(19) United States
(12) Patent Application Publication
(10) Pub. No.: US 2025/0094597 A1
(43) Pub. Date: Mar. 20, 2025

(54) IMAGE PROCESSING APPARATUS AND EXECUTION CONTROL METHOD OF REWRITE PROTECTION

(71) Applicant: SHARP KABUSHIKI KAISHA, Sakai City (JP)

(72) Inventor: Masaki HIGASHIURA, Sakai City (JP)

(21) Appl. No.: 18/829,629

(22) Filed: Sep. 10, 2024

(30) Foreign Application Priority Data
Sep. 19, 2023 (JP) 2023-151577

(51) Int. Cl. G06F 21/57; G06F 21/12; G06F 21/60

(52) U.S. Cl. CPC G06F 21/575; G06F 21/121; G06F 21/608

(57) ABSTRACT

An image processing apparatus includes a setter that sets any one of a first security setting and a second security setting different from the first security setting in the image processing apparatus, one or more storages that store firmware and a verification program verifying whether or not the firmware has been tampered with, and one or more controllers that control execution of rewrite protection for a part of a storage area including the verification program in accordance with the first security setting or the second security setting set in the image processing apparatus.

### TECHNICAL FIELD

The present disclosure relates to an image processing apparatus or the like.

### BACKGROUND ART

For example, in order to obtain a Common Criteria (CC) certification in a hard copy device such as a multifunction peripheral, security requirements defined in the collaborative Protection Profile for Hardcopy Devices (HCDcPP) need to be satisfied.

The security requirements defined in the HCDcPP include secure boot. The secure boot is one of security functions for restricting execution of a boot process in a case that tampering/damage of firmware is detected upon booting a device.

For example, an information processing apparatus has been known that reduces a verification time for verifying whether firmware has been tampered with.

### SUMMARY

### Technical Problem

An object of the present disclosure is to provide an image processing apparatus or the like capable of maintaining roots of trust related to verification of firmware in an appropriate state.

### Solution to Problem

In order to solve the above problem, an image processing apparatus according to the present disclosure includes a setter that sets any one of a first security setting and a second security setting different from the first security setting in the image processing apparatus, one or more storages that store firmware and a verification program verifying whether or not the firmware has been tampered with, and one or more controllers that control execution of rewrite protection for a part of a storage area including the verification program in accordance with the first security setting or the second security setting set in the image processing apparatus.

An execution control method of rewrite protection according to the present disclosure includes storing firmware and a verification program verifying whether or not the firmware has been tampered with, and controlling execution of rewrite protection for a part of a storage area including the verification program in accordance with a first security setting or a second security setting set in an image processing apparatus, the second security setting being different from the first security setting.

### Advantageous Effects of Invention

According to the present disclosure, it is possible to provide an image processing apparatus or the like capable of maintaining roots of trust related to verification of firmware in an appropriate state.

### BRIEF DESCRIPTION OF DRAWINGS

FIG. 1 is an external perspective view of a multifunction peripheral according to a first embodiment.

FIG. 2 is a diagram illustrating a functional configuration according to the first embodiment.

FIG. 3 is a diagram illustrating a memory map of a nonvolatile memory.

FIG. 4 is a flowchart illustrating a processing flow according to the first embodiment.

FIG. 5 is a flowchart illustrating a processing flow according to the first embodiment.

FIG. 6 is a diagram illustrating an operation example according to the first embodiment.

FIG. 7A and FIG. 7B are diagrams illustrating operation examples according to the first embodiment.

FIG. 8 is a diagram illustrating an operation example according to the first embodiment.

FIG. 9 is a flowchart illustrating a processing flow according to a second embodiment.

FIG. 10 is a flowchart illustrating a processing flow according to the second embodiment.

FIG. 11 is a diagram illustrating an operation example according to the second embodiment.

FIG. 12 is a diagram illustrating a condition combination of a verification flag and rewrite protection for achieving secure boot.

FIG. 13 is a diagram illustrating a modified example.

FIG. 14 is a diagram illustrating an advantage of secure boot according to the present disclosure.

### DESCRIPTION OF EMBODIMENTS

Embodiments according to the present disclosure are described below with reference to the drawings. Note that the following embodiments are examples illustrating the present disclosure, and the technical content of the explanation described in the claims is not limited to the following description.

CC certification is a system for evaluating IT products, based on the international security evaluation standard ISO/IEC15408. The CC certification is performed in order to ensure security in the government's procurement of civil consumer goods. The CC certification is an international system that is currently mutually approved by 31 countries.

In the CC certification, validity of the security function and justification of implementation are evaluated by a third party (evaluation organization). The third party confirms that the evaluation is based on the CC.

For example, in a hard copy device such as a multifunction peripheral, HCDcPP is defined as security requirement specifications for obtaining a CC certification. The HCDcPP includes secure boot, which is one of supported items required for adapting to the HCDcPP.

The secure boot is one of the security functions for restricting execution of a boot process in a case that tampering/damage of firmware is detected upon booting a device. In the secure boot, in order to detect tampering/damage of the firmware, a program code to be initially executed and encrypted data to be used for verification are protected from rewrite in terms of hardware as a root of trust.

The root of trust is unconditionally trusted, and the program code verified by the program (code) associated with the root of trust is consequently trusted.

In the related art, a part of an area of a nonvolatile memory storing firmware has been protected from rewrite as an initial code of the root of trust, and thus, a program code related to the initial code has not been able to be corrected by rewriting the nonvolatile memory in a case that the initial code partially has a defect or when a failure occurs.

The present disclosure achieves an image processing apparatus or the like capable of maintaining roots of trust related to verification of firmware in an appropriate state in the following embodiments.

### 1. First Embodiment

### 1.1 Functional Configuration

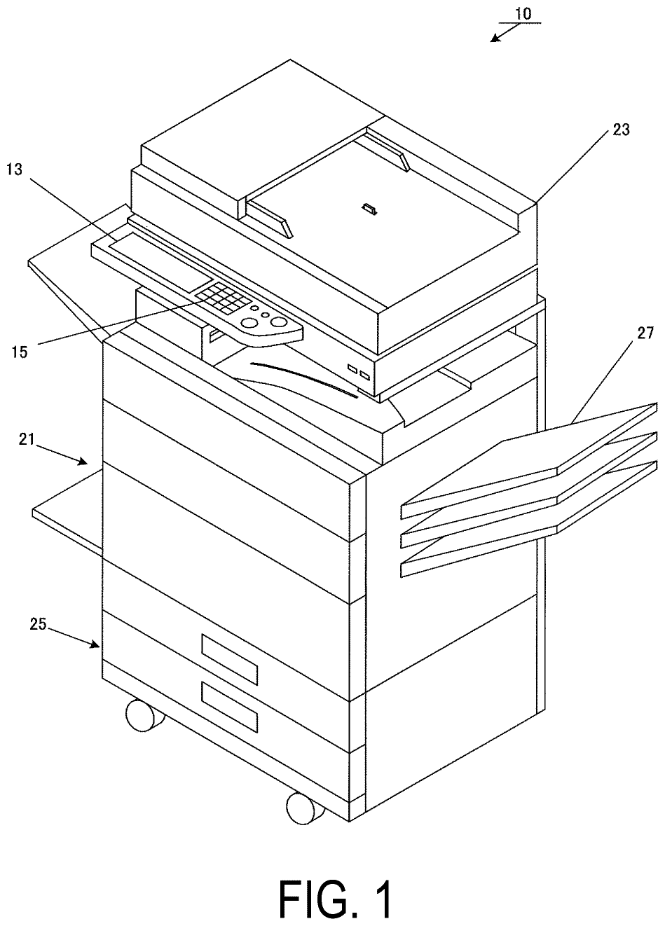

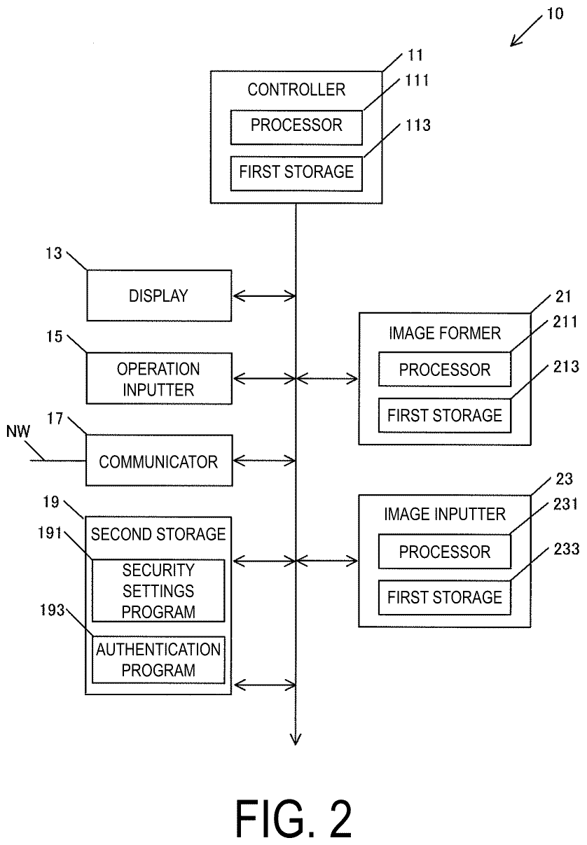

FIG. 1 is an external perspective view illustrating an overall configuration of a multifunction peripheral 10 as an image processing apparatus according to a first embodiment. FIG. 2 is a functional configuration diagram of the multifunction peripheral 10.

The multifunction peripheral 10 is an example of an image processing apparatus that can execute various kinds of jobs such as print, copy, fax, and image transmission in one housing. Note that the image processing apparatus according to the present disclosure is not limited to the multifunction peripheral 10, and may be an image processing apparatus specialized in a specific function such as a printer or a facsimile, for example.

The multifunction peripheral 10 is provided with functional units including a controller 11, a display 13, an operation inputter 15, a communicator 17, a second storage 19, an image former 21, and an image inputter 23.

The controller 11 controls the entire multifunction peripheral 10. The controller 11 includes a processor 111 including one or more processing devices (for example, a central processing unit (CPU), a system on a chip (SoC), or the like), and a first storage 113 storing firmware related to the controller 11. The processor 111 can function as the controller 11 by controlling driving of the hardware including the controller 11, based on the firmware.

The processor 111 reads a verification program code stored in the first storage 113 in response to input of a boot instruction of the multifunction peripheral 10 being input, thereby verifies the firmware. A beginning code in the verification program code is designated as an execution start address on a memory map of the first storage 113 described below. In a case that the boot instruction of the multifunction peripheral 10 is input, the processor 111 first reads the verification program code, thereby functions as the verification program to execute the verification of the firmware.

Here, the verification of the firmware according to the present disclosure is intended to determine whether or not to permit the boot (operation) of the hardware based on the firmware, based on processing of detecting tampering or damage of the firmware. In the present disclosure, a case that boot (operation) of hardware based on firmware is permitted by verification of the firmware is expressed as verification of the firmware being successful. On the other hand, a case that the boot (operation) of the hardware based on the firmware is not permitted by the verification of the firmware is expressed as verification of the firmware being failed.

For the verification of the firmware, for example, a digital signature scheme using a public key can be employed. In the digital signature scheme, a software developer calculates a hash value of the entire firmware and signs using a private key. The firmware and the signature are written (stored) in the first storage 113 at the time of factory shipment or at the time of firmware update.

When the multifunction peripheral 10 is booted, the processor 111 compares the hash value calculated from the entire firmware with a hash value obtained by decrypting the signature using the public key. In a case that the hash value of the entire firmware calculated upon booting matches the hash value obtained by decrypting the signature, the processor 111 determines that the verification of the firmware is successful. On the other hand, in a case that the hash value of the entire firmware calculated upon booting does not match the hash value obtained by decrypting the signature, the processor 111 determines that the verification of the firmware is failed.

The processor 111, in a case of determining that the verification of the firmware is successful, executes boot processing based on the firmware. On the other hand, the processor 111, in a case of determining that the verification of the firmware is failed, does not execute the boot processing based on the firmware. In this case, the processor 111 can notify a user of the multifunction peripheral 10 of the verification of the firmware being failed by displaying an error number or error contents related to the failure of the firmware on a touch panel or the like described below, for example. The processor 111 can also display contact information for customer service on the touch panel. Furthermore, in a case that backup firmware is prepared separately from the firmware related to verification, the processor 111 may recover the firmware of which verification is failed from the backup firmware.

The first storage 113 includes one or more storage devices that store at least the verification program code, the public key, the firmware, and the signature of the firmware. The type and configuration of the storage device(s) of the first storage 113 are not limited as long as the content once written therein cannot be rewritten later (referred to as rewrite protection in the present disclosure). Examples of the first storage 113 include a nonvolatile memory such as a mask read only memory (ROM), a programmable ROM (PROM), an erasable programmable ROM (EPROM), an electrically erasable and programmable ROM (EEPROM), a flash memory, a magnetoresistive random access memory (MRAM), or a ferroelectric random access memory (FRAM (trade name)), for example.

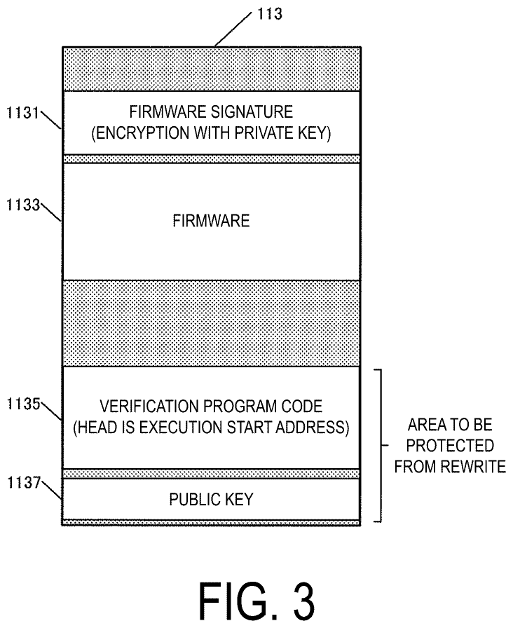

Here, an example of a memory map of the first storage 113 according to the present disclosure is described with reference to FIG. 3. FIG. 3 is an image diagram in which firmware or the like is memory-mapped in a nonvolatile memory as the first storage 113.

As illustrated in FIG. 3, the first storage 113 stores a firmware signature 1131, firmware 1133, a verification program code 1135, and a public key 1137.

In the first embodiment, a part of a storage area of the first storage 113 including the verification program code 1135 and the public key 1137 is set as an area to be protected from rewrite.

In the first embodiment, execution of the rewrite protection for the area to be protected from rewrite is controlled in accordance with a first security setting or a second security setting in the multifunction peripheral 10 described below. Details are described below.

Again, returning to FIG. 2, the display 13 is a display device that displays various types of information for the user or the like. The display 13 can include, for example, a liquid crystal display (LCD), an organic electro-luminescence (EL) display, or the like.

The operation inputter 15 is an input device that receives input of information by the user or the like. The operation inputter 15 can include, for example, various input devices such as operation keys such as hardware keys and software keys, and buttons. Note that the operation inputter 15 can include a touch panel that enables input via the display 13. In this case, as an input method for the touch panel, for example, a general method such as a resistance film method, an infrared beam method, an electromagnetic induction method, or an electrostatic capacitance method can be employed.

The communicator 17 includes, for example, one or both of wired and wireless interfaces for performing communication with another apparatus (terminal apparatus 30) via a network NW such as a local area network (LAN), a wide area network (WAN), the Internet, a telephone line, or a fax line. In addition, the communicator 17 may include an interface related to a (short-range) wireless communication technology such as Bluetooth (trade name), near-field communication (NFC), Wi-Fi (trade name), ZigBee (trade name), infrared data association (IrDA), or a wireless USB.

The second storage 19 includes one or more storage devices that store various programs and various types of data necessary for the operation of the multifunction peripheral 10. The second storage 19 may include, for example, a storage device such as a random access memory (RAM), a hard disk drive (HDD), a solid state drive (SSD), or a read only memory (ROM).

In the first embodiment, the second storage 19 stores a security settings program 191 and an authentication program 193.

The security settings program 191 is a program read by the controller 11 when receiving a setting input related to the security set in the multifunction peripheral 10. The controller 11 having read the security settings program 191 functions as a setter and receives a setting instruction of the first security setting from an administrator (user) via a system setting screen described below. Upon receiving the setting instruction of the first security setting from the administrator (user), the controller 11 shifts a security state for the multifunction peripheral 10 to a high security state. Here, the high security state means that at least the state of security set to the multifunction peripheral 10 is at a security level that satisfies an execution requirement of the secure boot. On the other hand, in the present disclosure, a setting in which the multifunction peripheral 10 is set to security lower the high security state or security of a non-security state where no security is set is referred to as a second security setting.

The authentication program 193 is a program read by the controller 11 when the controller 11 authenticates a user who attempts to log in to the multifunction peripheral 10. The controller 11 having read the authentication program 193 operates as an authenticator that operates based on a user authentication function. In a case that the user authentication function is enabled, the controller 11 display a login screen (not illustrated) on the touch panel to receive input, from the user, of authentication information related to the user authentication. For example, in a case that an authentication condition is a combination of a login user name and a login password, the controller 11 can perform the user authentication by storing login user names and login passwords related to the user authentication in association with each other in advance and checking a login user name and a login password input via the login screen against the stored login user names and login passwords. Note that the user authentication can be performed through, for example, possession-based authentication using a token, a key, an integrated circuit (IC) card, or a smartphone, or biometric authentication such as face authentication or fingerprint authentication, in addition to knowledge-based authentication combining a login user name and a login password. Note that the controller 11 can receive setting of enabling/disabling the user authentication function from an administrator having an administration authority via the system setting screen or the like described below.

The image former 21 feeds a sheet from a sheet feed tray 25, forms an image of image information related to a print job or the like on the sheet, and then discharges the sheet to a sheet discharge tray 27. The image former 21 can include, for example, a laser printer using an electrophotographic system. In this case, the image former 21 performs image formation using toners supplied from toner cartridges (not illustrated) corresponding to toner colors (for example, cyan, magenta, yellow, and black).

The image former 21 includes, in addition to hardware necessary for image formation, a processor 211 that controls driving of the hardware and a first storage 213 that stores firmware related to the image former 21. The processor 211 can function as the image former 21 by controlling driving of hardware necessary for image formation, based on firmware.

The configuration of the processor 211 may be the same as that of the processor 111 related to the controller 11. The configuration of the first storage 213 may also be the same as that of the first storage 113 related to the controller 11 except for only the firmware stored therein which is different from the first storage 113. Therefore, descriptions of the processor 211 and the first storage 213 are omitted here.

The image inputter 23 generates image information by scanning a document. The image inputter 23 can be configured as a scanner device that is provided with an image sensor such as a charge coupled device (CCD) or a contact image sensor (CIS), and that includes an automatic document feeder (ADF) having a double-sided simultaneous reading function, a flatbed on which a document is placed to be read, or the like. The configuration of the image inputter 23 is not particularly limited as long as the image inputter 23 can generate image information by reading a reflected light image from an original image using the image sensor. Note that the image inputter 23 also can be configured as an interface that can acquire, for example, document information stored in an external storage medium such as a universal serial bus (USB) memory and image information included a print job transmitted from an external device.

The image inputter 23 includes, in addition to hardware necessary for image input, a processor 231 that controls driving of the hardware, and a first storage 233 that stores firmware related to the image inputter 23. The processor 231 can function as the image inputter 23 by controlling driving of hardware necessary for image input, based on firmware.

The configuration of the processor 231 may be the same as that of the processor 111 related to the controller 11. The configuration of the first storage 233 may also be the same as that of the first storage 113 related to the controller 11 except for only the firmware stored therein which is different from the first storage 113. Therefore, descriptions of the processor 231 and the first storage 233 are omitted here.

### 1.2 Processing Flow

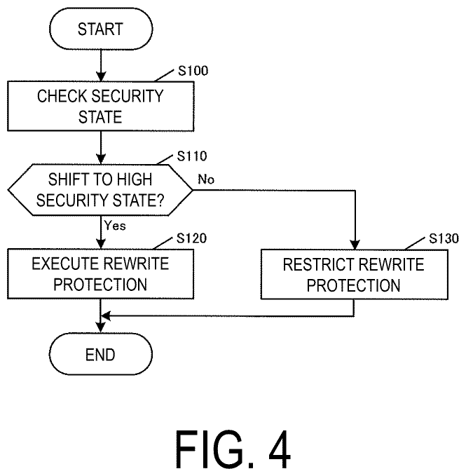

Next, a processing flow according to the first embodiment is described. FIG. 4 is a flowchart illustrating execution control of the rewrite protection according to the first embodiment. The controller 11 of the multifunction peripheral 10 executes processing according to FIG. 4 by reading the security settings program 191 stored in the second storage 19.

The first embodiment is described on the assumption that at least at the time of factory shipment or at the time of firmware update, the rewrite protection is not executed for the storage area to be protected from rewrite including the verification program code 1135 and the public key 1137 illustrated in FIG. 3.

When the processing is started, the controller 11 checks the security state of the multifunction peripheral 10 (step S100). The controller 11, in a case of determining that the security state of the multifunction peripheral 10 has shifted to the high security state, executes the rewrite protection for the storage area to be protected from rewrite including the verification program code 1135 and the public key 1137 (step S110; Yes, then the processing goes to step S120).

On the other hand, the controller 11, in a case of determining that the security state of the multifunction peripheral 10 has not shifted to the high security state, restricts rewrite of the storage area to be protected from rewrite (step S110; No, then the processing goes to step S130) and ends the processing.

In the first embodiment, during a period from the time of factory shipment or firmware update until the security state of the multifunction peripheral 10 shifts to the high security state, rewriting of the storage area to be protected from rewrite is not restricted. During this period, for example, when a defect or the like is found in the verification program code 1135, the administrator (user) can correct the verification program code 1135.

Then, when the administrator (user) sets the security setting for the multifunction peripheral 10 to the first security setting and the security state of the multifunction peripheral 10 shifts to the high security state, the controller 11 executes the rewrite protection for the storage area to be protected from rewrite. After the security state of the multifunction peripheral 10 shifts to the high security state, the verification program code 1135 or the like related to the storage area to be protected from rewrite cannot be changed, and thus trust as a root of trust can be obtained. Then, the firmware verified by the verification program which is the root of trust can obtain trust.

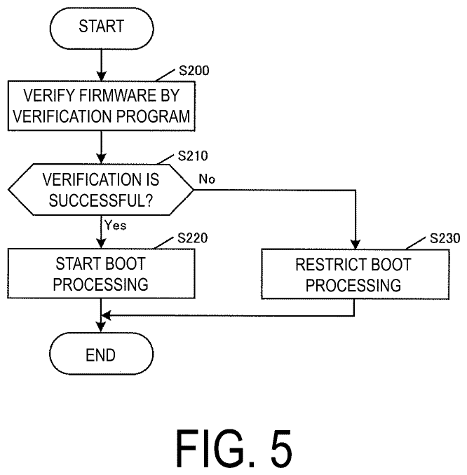

Next, the boot processing by the processor 111 depending on a result of the verification of the firmware 1133 is described with reference to a flowchart of FIG. 5.

Note that the verification of the firmware in each of the respective functional units of the controller 11, the image former 21, and the image inputter 23 can be executed similarly between the functional units. Therefore, in the following description, the verification of the firmware in the controller 11 is described as an example.

When the boot instruction of the multifunction peripheral 10 is input, the processor 111 of the controller 11 reads the verification program code 1135 and starts the verification of the firmware 1133 (step S200).

The processor 111 determines whether the verification of the firmware 1133 is successful (step S210). The processor 111, in a case of determining that the verification of the firmware is successful, starts the boot processing based on the firmware 1133 and ends the processing (step S210; Yes, then the processing goes to step S220). On the other hand, the processor 111, in a case of determining that the verification of the firmware is failed, restricts the boot processing based on the firmware 1133 and ends the processing (step S210; No, then the processing goes to step S230).

FIG. 5 illustrates assuming that the verifications of the firmware in the respective functional units of the controller 11, the image former 21, and the image inputter 23 are executed by the processors 111, 211, and 231 included in the respective functional units. Note that the verifications of the firmware in the respective functional units can be executed in series in the order of the controller 11, the image former 21, and the image inputter 23, for example, in response to receiving the input of the boot instruction of the multifunction peripheral 10. Further, the verifications of the firmware in the respective functional units may be executed simultaneously (in parallel) in response to receiving the input of the boot instruction of the multifunction peripheral 10.

Here, in a case that the processor 111 of the controller 11 supports multithreading, verifications of the firmware in the image former 21 and the image inputter 23 may be executed by the processor 111 of the controller 11. In this case, the processor 111 of the controller 11 preferably restricts the boot of the processor 211 of the image former 21 and the boot of the processor 231 of the image inputter 23 until the verifications of the firmware in the image former 21 and the image inputter 23 are successful.

Furthermore, a processor (microcomputer) that exclusively executes verification of firmware may be provided separately from the processor 111 of the controller 11, the processor 211 of the image former 21, and the processor 231 of the image inputter 23, and the processor (microcomputer) may be caused to execute the verifications of the firmware related to the respective functional units of the controller 11, the image former 21, and the image inputter 23.

The present disclosure describes the firmware to be verified as the firmware related to the controller 11, the image former 21, or the image inputter 23. However, firmware related to other functional units, for example, functional units for a facsimile and an image transmission may be added to the firmware to be verified.

### 1.3 Operation Examples

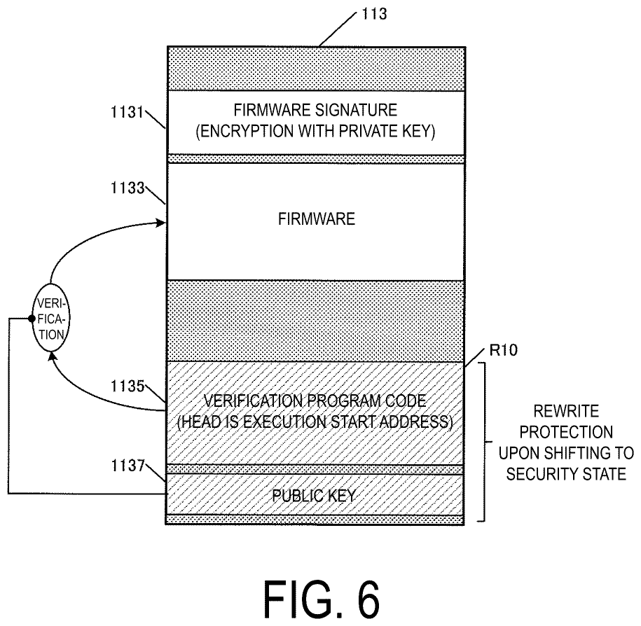

Next, operation examples according to the first embodiment are described. FIG. 6 illustrates a state of the memory map of the first storage 113 illustrated in FIG. 3 in which a part of the storage area of the first storage 113 including the verification program code 1135 and the public key 1137 is protected as a protection area R10, as the multifunction peripheral 10 shifts to the high security state.

Since the storage area including the verification program code 1135 and the public key 1137 is protected as the protection area R10, the verification program code 1135 or the like obtains trust as a root of trust. The verification program code 1135 and the public key 1137, which are the roots of trust, are used to verify the firmware 1133. In a case that the verification of the firmware by the processor 111 is successful, the execution requirement of the secure boot is satisfied, and the processor 111 can start the boot processing based on the firmware.

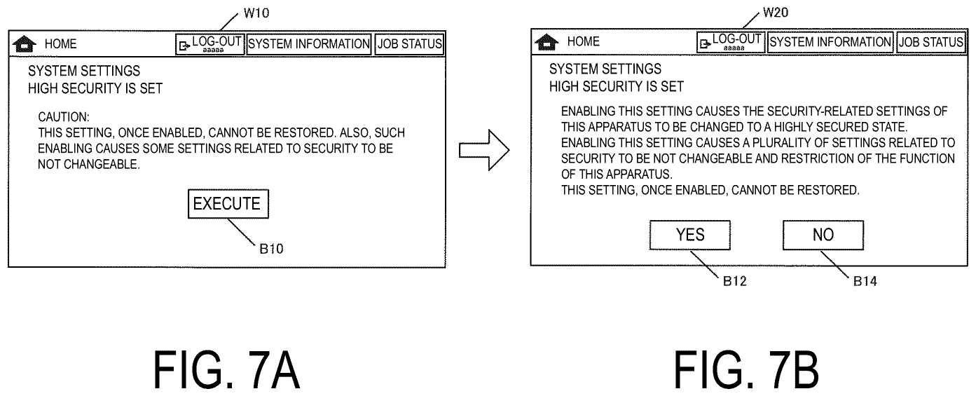

FIG. 7A is a diagram illustrating an example of a screen configuration example of a system setting screen W10 for receiving a setting instruction of the first security setting from the administrator (user).

The system setting screen W10 includes an execution button B10 for receiving an instruction to execute setting of high security as the first security setting. The high security setting received via the system setting screen W10 can be set to be enabled by the administrator (user) having the administration authority authenticated by the authenticator of the multifunction peripheral 10.

In a case that the administrator (user) selects the execution button B10, the system setting screen W10 transitions to a system setting screen W20 illustrated in FIG. 7B.

The system setting screen W20 includes a notice when the multifunction peripheral 10 is shifted to the high security state, and a YES-button B12 and a NO-button B14.

The YES-button B12 is a button for receiving a consent of the administrator (user) who has confirmed the notice. When the administrator (user) selects the YES-button B12, the controller 11 sets the first security setting in the multifunction peripheral 10. The NO-button B14 is a button for receiving a cancel instruction from the administrator (user). When the administrator (user) selects the NO-button B14, the controller 11 does not set the first security setting in the multifunction peripheral 10 and ends the processing.

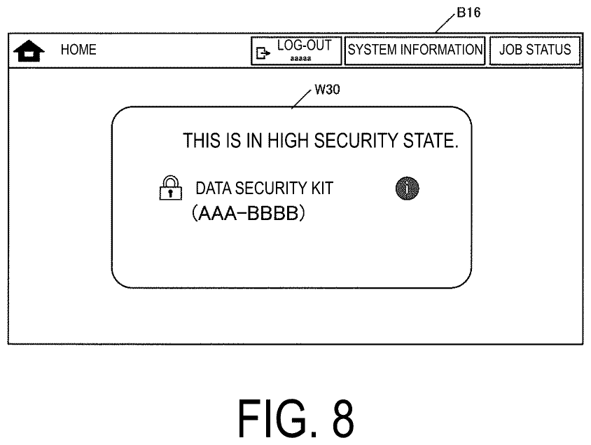

FIG. 8 is a display configuration example of a confirmation screen W30 for confirming the security state of the multifunction peripheral 10. Not only the administrator (user) but also a general user and a guest user can refer to the confirmation screen W30. When the user selects a system information button B16, the controller 11 displays the confirmation screen W30. On the confirmation screen W30, the security state of the multifunction peripheral 10 (for example, “This is in high security state.”), and for example, a name of an optional device (for example, “data security kit (AAA-BBBB)”) when the optional device or the like needs to be mounted in order to set the first security setting can be displayed together.

In the first embodiment, during the period from the time of factory shipment or firmware update until the security state of the multifunction peripheral shifts to the high security state, rewriting of the storage area to be protected from rewrite is not restricted. Therefore, for example, when a defect or the like is found in the verification program code, the administrator (user) can correct the verification program code.

Then, when the administrator (user) sets the security setting for the multifunction peripheral to the first security setting and the security state of the multifunction peripheral shifts to the high security state, the controller executes the rewrite protection for the storage area to be protected from rewrite. After the security state of the multifunction peripheral shifts to the high security state, the verification program code or the like related to the storage area to be protected from rewrite cannot be changed, and thus trust as a root of trust can be obtained.

As described above, according to the first embodiment, the root of trust related to the verification of the firmware can be maintained in an appropriate state, and the secure boot based on the root of trust can be achieved.

### 2. Second Embodiment

In the second embodiment, a verification flag is provided as the setting information that decides whether to execute the verification of the firmware based on the verification program in the first embodiment.

### 2.1 Functional Configuration

A functional configuration of a multifunction peripheral according to the second embodiment can be similar to the functional configuration of the multifunction peripheral 10 according to the first embodiment. Therefore, the description is given using the same reference signs as the first embodiment, omitting the functional configuration of the multifunction peripheral 10 according to the second embodiment.

### 2.2 Processing Flow

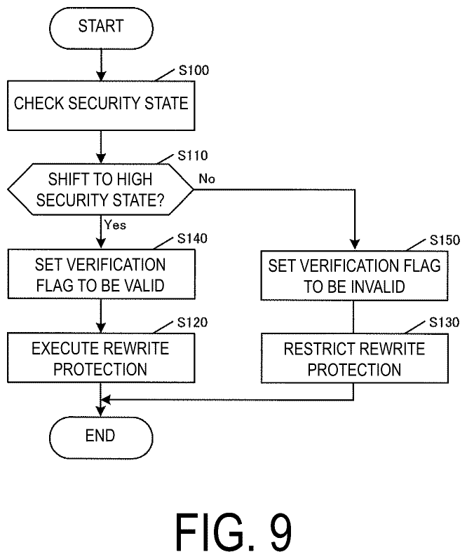

A processing flow related to the execution control of the rewrite protection according to the second embodiment is obtained by replacing the flowchart of FIG. 4 with a flowchart of FIG. 9. Therefore, the same processing is denoted by the same step number and the description thereof is omitted, and differences are described.

The controller 11 of the multifunction peripheral 10, in the case of determining that the security state of the multifunction peripheral 10 has shifted to the high security state, sets a value of the verification flag to be valid (step S110; Yes, then the processing goes to step S140).

Here, the verification flag is a flag identifier for the processor 111 to determine whether to execute the verification of the firmware 1133, based on the verification program code 1135. In a case that the value of the verification flag is set to be valid, the processor 111 executes the verification of the firmware 1133 based on the verification program code 1135. On the other hand, when the value of the verification flag is set to be invalid, the processor 111 omits (avoids) execution of the verification of the firmware 1133, based on the verification program code 1135.

The controller 11 executes the rewrite protection for the storage area to be protected from rewrite including the verification program code 1135 and the public key 1137 as well as the value (valid) of the verification flag (from step S140 to step S120).

On the other hand, the controller 11, in the case of determining that the security state of the multifunction peripheral 10 has not shifted to the high security state, sets the value of the verification flag to be invalid (step S110; No, then the processing goes to step S150). Then, the controller 11 does not execute the rewrite protection for the storage area to be protected from rewrite (step S130), and ends the processing.

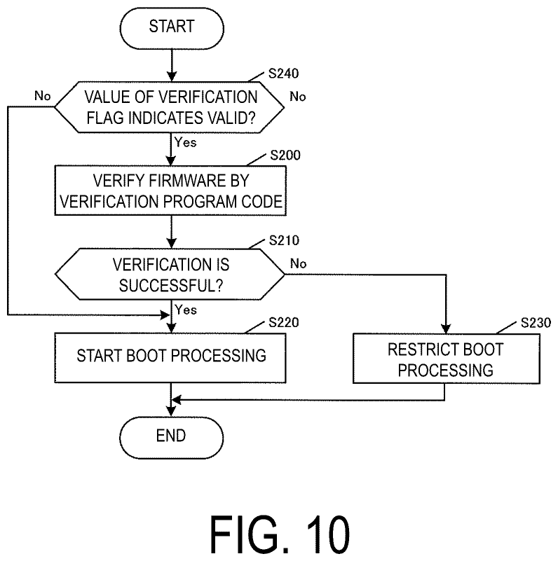

Next, the boot processing by the processor 111 depending on the result of the verification of the firmware 1133 according to the second embodiment is described with reference to a flowchart of FIG. 10.

A flow of the boot processing by the processor 111 depending on the result of the verification of the firmware 1133 according to the second embodiment is obtained by replacing the flowchart of FIG. 5 with the flowchart of FIG. 10. Therefore, the same processing is denoted by the same step number and the description thereof is omitted, and differences are described.

When the boot instruction of the multifunction peripheral 10 is input, the processor 111 of the controller 11 determines whether or not the value of the verification flag is valid (step S240). The processor 111, in a case of determining that the value of the verification flag is valid, executes the verification of the firmware 1133 by the verification program code 1135 (step S240; Yes, then the processing goes to step S200).

On the other hand, the processor 111, in a case of determining that the value of the verification flag is invalid, omits (avoids) the verification of the firmware 1133 by the verification program code 1135, and starts the boot processing based on the firmware 1133 (step S240; No, then the processing goes to step S220).

### 2.3 Operation Example

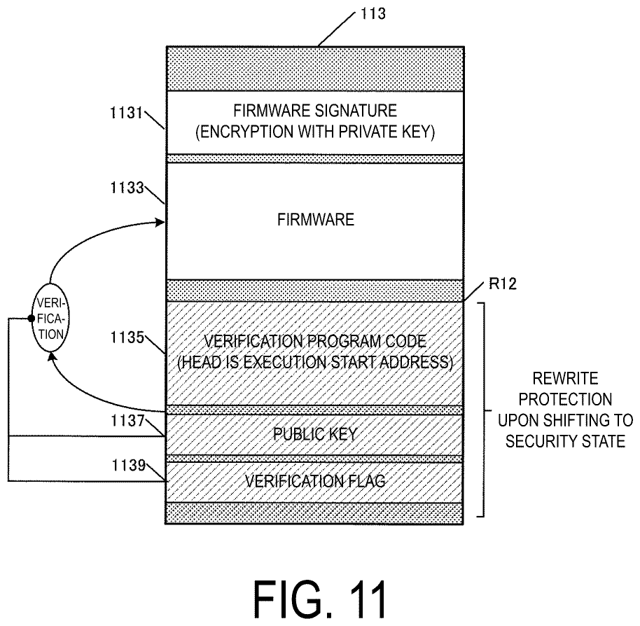

Next, an operation example according to the second embodiment will be described. FIG. 11 illustrates a state of the memory map of the first storage 113 illustrated in FIG. 3 in which a part of the storage area of the first storage 113 including the verification program code 1135, the public key 1137, and verification flag 1139 is protected as a protection area R12, as the multifunction peripheral 10 shifts to the high security state.

Since the part of the storage area including the verification program code 1135, the public key 1137, and the verification flag 1139 is protected as the protection area R12, the verification program code 1135 or the like obtains trust as a root of trust. The verification program code 1135 and the public key 1137, which are the roots of trust, are used to verify the firmware 1133, based on the verification flag 1139. In a case that the verification of the firmware 1133 by the processor 111 is successful, the execution requirement of the secure boot is satisfied, and the processor 111 can start the boot processing based on the firmware 1133.

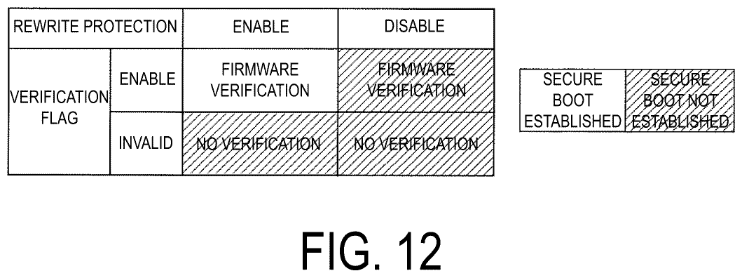

FIG. 12 is a diagram illustrating a condition combination of the verification flag 1139 and the rewrite protection for achieving secure boot in the second embodiment.

For example, in a case that the value of the verification flag 1139 is valid and the rewrite protection is enabled, the verification of the firmware 1133 is executed by the verification program code 1135 or the like which is protected from rewrite, and thus the condition satisfies the execution requirement of the secure boot.

In a case that the value of the verification flag 1139 is valid and the rewrite protection is disabled, the verification of the firmware 1133 is executed by the verification program code 1135 or the like which is not protected from rewrite, and thus the condition does not satisfy the execution requirement of the secure boot.

In a case that the value of the verification flag 1139 is invalid and the rewrite protection is enabled, the verification of the firmware 1133 is not executed by the verification program code 1135 or the like which is protected from rewrite, and thus the condition does not satisfy the execution requirement of the secure boot.

In a case that the value of the verification flag 1139 is invalid and the rewrite protection is disabled, the verification of the firmware 1133 is not executed by the verification program code 1135 or the like which is not protected from rewrite, and thus the condition does not satisfy the execution requirement of the secure boot.

As illustrated in FIG. 12, in the second embodiment, in the case that the value of the verification flag 1139 is valid and the rewrite protection is enabled, the execution requirement of the secure boot can be satisfied.

In the second embodiment, the verification flag 1139 is protected from rewrite as the protection area R12, so that the value of the verification flag 1139 cannot be rewritten. As a result, the verification of the firmware 1133 is advantageously not avoided, as the multifunction peripheral 10 shifts to the high security state.

On the other hand, in the second embodiment, the execution of the verification of the firmware 1133 can be restricted by setting the value of the verification flag 1139 to be invalid. According to the second embodiment, restricting of the execution of the verification of the firmware 1133 can also reduce a delay in a boot time caused by the verification.

In the case that the processor 111 of the controller 11 supports multithreading, for example, when the firmware 1133 is divided into a plurality of parts such as Boot/Main, a verification time can be expected to be shortened by verifying sequences of these parts in parallel at the time of verification of the firmware 1133.

As described above, in the second embodiment, the execution of the verification of the firmware based on the verification program code can be controlled based on (the value of) the verification flag. Therefore, according to the second embodiment, in addition to the effects of the first embodiment, for example, an effect of shortening the boot time of the multi-function peripheral can be expected.

### 3. Modified Example

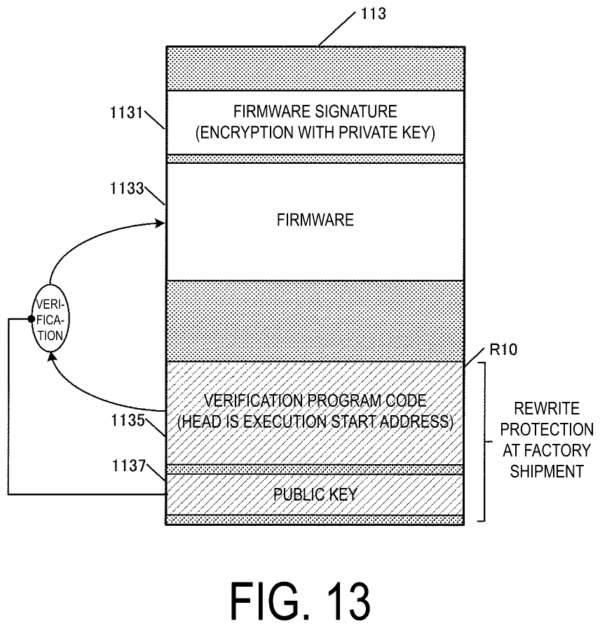

A modified example is described with reference to FIG. 13 in which the storage area including the verification program code 1135 and the public key 1137 as the roots of trust is to be protected from rewrite, and the secure boot can be executed.

FIG. 13 illustrates a state of the memory map of the first storage 113 illustrated in FIG. 3 in which a part of the storage area of the first storage 113 including the verification program code 1135 and the public key 1137 is protected as the protection area R10 at the time of factory shipment.

Since the storage area including the verification program code 1135 and the public key 1137 is protected as the protection area R10 at the time of factory shipment, the verification program code 1135 or the like obtains trust as a root of trust. The verification program code 1135 and the public key 1137, which are the roots of trust, are used to verify the firmware 1133. In a case that the verification of the firmware 1133 by the processor 111 is successful, the execution requirement of the secure boot is satisfied, and the processor 111 can start the boot processing based on the firmware 1133.

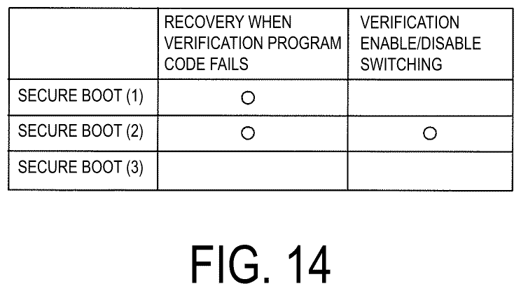

FIG. 14 is a table illustrating merits of the secure boot (secure boot (1)) according to the first embodiment, the secure boot (secure boot (2)) according to the second embodiment, and the secure boot (secure boot (3)) according to the modified example.

All of the secure boot (1), the secure boot (2), and the secure boot (3) are secure boots that satisfy the security requirements defined in the HCDcPP.

In the secure boot (1) according to the first embodiment, during the period from the time of factory shipment or firmware update until the security state of the multifunction peripheral 10 shifts to the high security state, rewriting of the storage area to be protected from rewrite is not restricted. During this period, since the verification program code 1135 can be corrected, the verification program code 1135 in which a defect has occurred can be restored.

In the secure boot (2) according to the second embodiment, in addition to the merit of the secure boot (1), whether or not to execute the verification of the firmware 1133 based on the verification program code 1135 can be switched. In the secure boot (2), the execution of the verification of the firmware 1133 can be restricted by setting the value of the verification flag 1139 to be invalid. Restricting of the execution of the verification of the firmware 1133 can also reduce a delay in a boot time caused by the verification.

The present disclosure is not limited to the embodiments described above and can be changed in various manners. In other words, embodiments obtained by combining technical mechanisms appropriately changed without departing from the gist of the present disclosure are also included in the technical scope of the present disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

A computer-readable non-transitory recording medium storing programs in an information processing apparatus may be any of a semiconductor medium (for example, a ROM, a nonvolatile memory card, or the like), an optical recording medium or a magneto-optical recording medium (for example, a digital versatile disc (DVD), a magneto optical disc (MO), a mini disc (MD), a compact disc (CD), a Blu-ray (trade name) disc (BD) or the like), a magnetic recording medium (for example, a magnetic tape, a flexible disk, or the like), or the like. In this case, not only the aforementioned functions of the embodiments are implemented by reading and executing programs stored in the storage medium by a computer of the information processing apparatus, but also the functions of the present disclosure are implemented by performing processing in cooperation with an operating system, another application program, or the like, based on instructions of the programs.

In a case that the programs are distributed to the market, the programs can be stored and distributed in a portable recording medium, or can be transferred to a server computer connected via a network such as the Internet. In this case, it is a matter of course that the storage device of the server computer is also included in the present disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case that an integrated circuit technology that replaces the current integrated circuit becomes available due to advancement of the semiconductor technology, one or more aspects of the present disclosure can use a new integrated circuit based on the new integrated circuit technology.

### REFERENCE SIGNS LIST

10 Multifunction peripheral
11 Controller
111 Processor
113 First storage
13 Display
15 Operation inputter
17 Communicator
19 Second storage
191 Security settings program
193 Authentication program
21 Image former
211 Processor
213 First storage
23 Image inputter
231 Processor
233 First storage

1. An image processing apparatus comprising:
a setter that sets any one of a first security setting and a second security setting different from the first security setting in the image processing apparatus;
one or more storages that store firmware and a verification program verifying whether or not the firmware has been tampered with; and
one or more controllers that control execution of rewrite protection for a part of a storage area including the verification program in accordance with the first security setting or the second security setting set in the image processing apparatus.

2. The image processing apparatus according to claim 1, wherein
the one or more controllers
execute the rewrite protection in a case that the first security setting is set, and
restrict execution of the rewrite protection in a case that the second security setting is set.

3. The image processing apparatus according to claim 2, wherein
the setter sets the second security setting during a period from factory shipment of the image processing apparatus until the first security setting is set.

4. The image processing apparatus according to claim 1, wherein
the one or more storages store setting information that decides to enable or disable verification by the verification program in the part of the storage area.

5. The image processing apparatus according to claim 4, further comprising:
a processor that executes boot processing of the firmware, wherein
upon the boot processing, the processor executes verification by the verification program in a case that the enabling is set in the setting information, and omits the verification by the verification program and boots the firmware in a case that the disabling is set in the setting information.

6. The image processing apparatus according to claim 1, wherein
the firmware includes firmware related to the one or more controllers and firmware related to an image inputter or an image former.

7. An execution control method of rewrite protection, the execution control method of rewrite protection comprising:
storing firmware and a verification program verifying whether or not the firmware has been tampered with; and
controlling execution of rewrite protection for a part of a storage area including the verification program in accordance with a first security setting or a second security setting set in an image processing apparatus, the second security setting being different from the first security setting.
